(19) United States
(12) Patent Application Publication
(10) Pub. No.: US 2013/0062849 A1
(43) Pub. Date: Mar. 14, 2013

(54) CTBA WITH IMPROVED COMPLIANCE CHARACTERISTICS

(71) Applicants: Sungjin KIM, Hwaseong-si (KR); Seongho An, Seoul (KR); Byongcheol Kim, Seoul (KR)

(72) Inventors: Sungjin KIM, Hwaseong-si (KR); Seongho An, Seoul (KR); Byongcheol Kim, Seoul (KR)

(73) Assignee: HYUNDAI MOTOR COMPANY, Seoul (KR)

(21) Appl. No.: 13/307,978

(22) Filed: Nov. 30, 2011

(30) Foreign Application Priority Data
Sep. 8, 2011 (KR) 10-2011-0091348

(51) Int. Cl. B62D 7/20; B60B 35/02; B62D 7/16

(52) U.S. Cl. 280/93.511; 280/93.51

(57) ABSTRACT

A CTBA with improved compliance characteristics has a simple structure and can control a tow value of a rear wheel to be towed in while steering is performed in. The CTBA may include trailing arms and carriers on which rear wheels are mounted via carrier brackets at both ends of a torsion beam, a mounting bracket fixed to the bottom of a vehicle body, and a steering rod of which one end is linked to the carrier and the other end is linked to the mounting bracket.

### CROSS-REFERENCE TO RELATED APPLICATIONS

The present application claims the priority of Korean Patent Application Number 10-2011-0091348 filed Sep. 8, 2011, the entire contents of which application is incorporated herein for all purposes by this reference.

### BACKGROUND OF INVENTION

1. Field of Invention

The present invention relates to a coupled torsion beam axle (CTBA) suspension which is one type of a suspension of a vehicle, and more particularly, to a CTBA having a simple structure and with improved compliance characteristics that can control a tow value of a rear wheel in steering to be towed in.

2. Description of Related Art

A coupled torsion beam axle (CTBA) which is one type of a suspension of a vehicle has the small number of components and excellent durability, and is easily serviced due to a simple structure and relatively more inexpensive than other suspension devices, and as a result, the CTBA is adopted primarily for a small-sized vehicle.

Referring to a substantial structure of the CTBA suspension mechanism, as shown in FIGS. 1 and 2, the CTBA 100 includes a torsion beam 111, trailing arms 112 that are provided at both ends of torsion beam 111, and carriers 113 on which rear wheels RWs are mounted provided in trailing arms 112, respectively.

However, CTBA 100 has a structural characteristic in that rear wheels RWs are towed out when the vehicle turns round. Therefore, a rear wheel steering device may be provided in the CTBA as disclosed in a prior art document of KR 10-2006-0006797 A in order to improve handling and driving stability. As shown in FIG. 1, when a side force Fs acts while the vehicle turns round, rear wheel RW receiving side force Fs is towed out in direction A as shown in FIG. 1 or when an outer wheel of rear wheel RW bumps (B) and thus an inner wheel thereof rebounds (R), a tow value of rear wheel RW is towed out as shown in FIG. 2 to damage steering stability. Therefore, the tow value of rear wheel RW needs to be controlled by using an actuator and a link member.

That is, the actuator and the link member that can control the tow value of the rear wheel are provided in the CTBA and a controller actuates the actuator according to a driving condition to control the tow value of the rear wheel.

However, as described above, since the technology that controls the tow value of the rear wheel through electronic control is expensive, the manufacturing cost of the vehicle is increased and a configuration is complicated.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a coupled torsion beam axle (CTBA) with improved compliance characteristics that has a simple structure to enable a tow value of a rear wheel to be structurally towed in during steering by a link structure without electronic control.

Various aspects of the present invention provide for a CTBA with improved compliance characteristics, which includes trailing arms and carriers on which rear wheels are mounted via carrier brackets at both ends of a torsion beam, includes a mounting bracket fixed to the bottom of a vehicle body; and a steering rod of which one end is linked to the carrier and the other end is linked to the mounting bracket.

The steering rod may be connected to the carrier by a ball joint.

One end of the steering rod may be connected to the carrier to be lower than the mounting bracket.

The mounting bracket may be positioned in the rear of the center of the rear wheel.

The mounting bracket may have a cross section which is bent in a ‘U’ shape of which one side is opened and the steering rod is inserted into the inner part of the mounting bracket and connected with the mounting bracket by a pin joint.

According to a CTBA with improved compliance characteristics according to various aspects of the present invention, a steering rod holds a rear wheel while bumping or steering in a simple structure, and as a result, a tow value of the rear wheel is towed in, thereby improving driving stability.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a plan view of a coupled torsion beam axle (CTBA) in the related art.

FIG. 2 is a bottom view of a CTBA in the related art.

FIG. 3 is a plan view of an exemplary CTBA with improved compliance characteristics according to the present invention.

FIG. 4 is a bottom view of an exemplary CTBA with improved compliance characteristics according to the present invention.

FIG. 5 is an enlarged perspective view of a part of an exemplary CTBA with improved compliance characteristics according to the present invention.

FIGS. 6 and 7 are diagrams specifically showing a mounting bracket part of an exemplary CTBA with improved compliance characteristics according to the present invention.

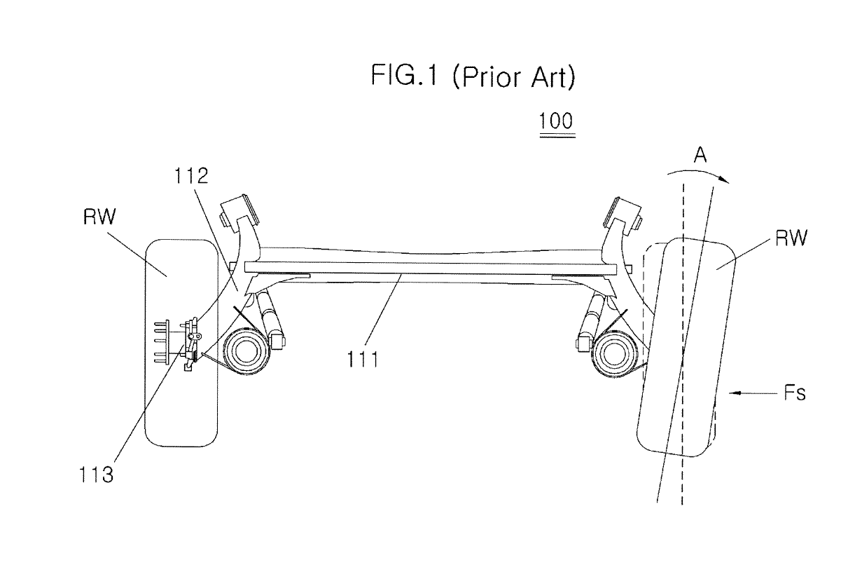

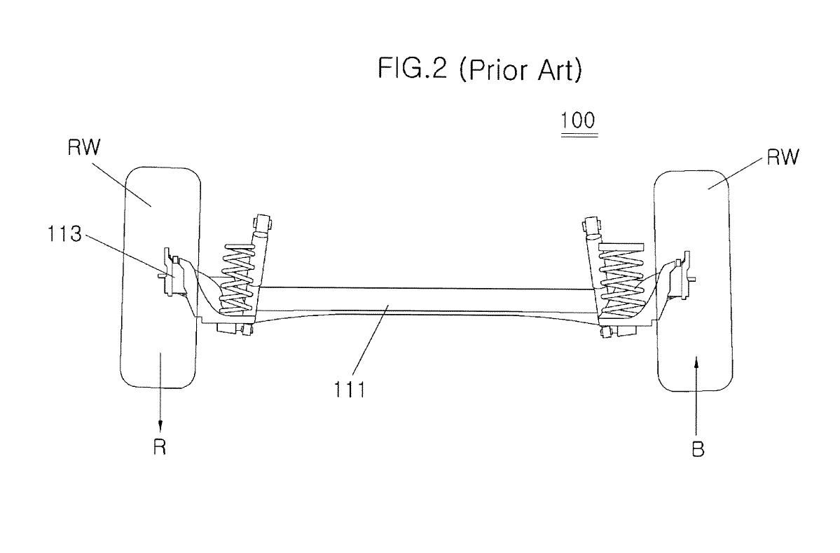

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

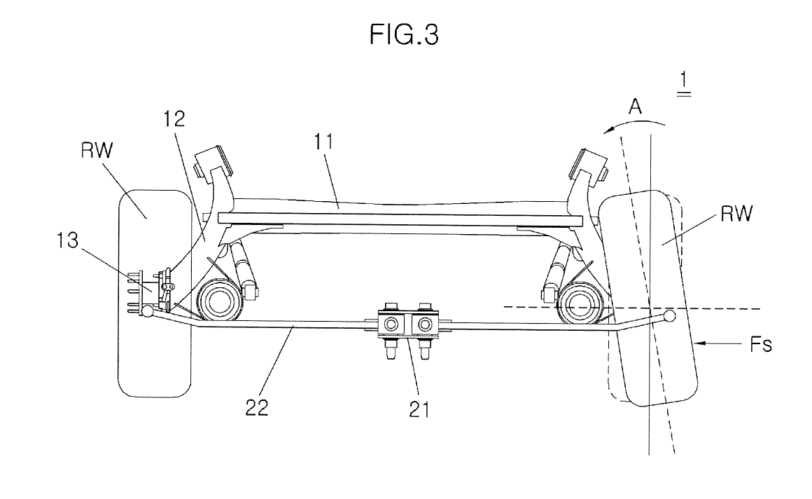

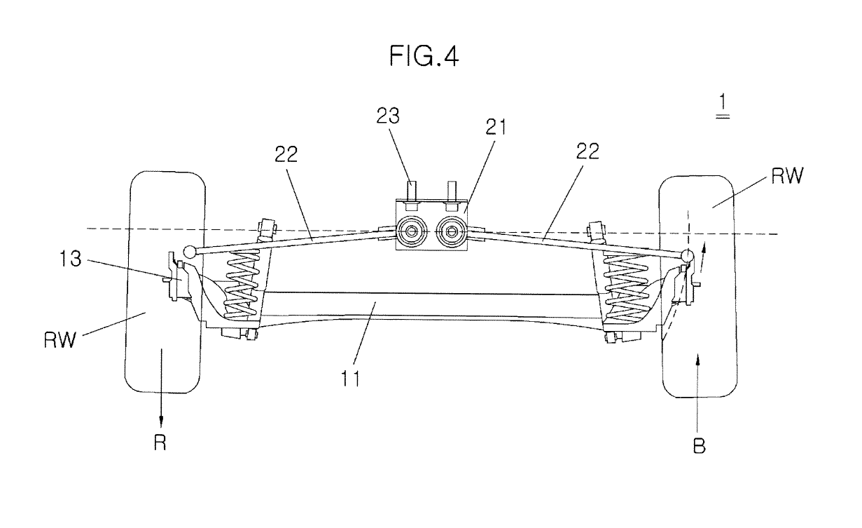

As shown in FIGS. 3 and 4, a coupled torsion beam axle (CTBA) with improved compliance characteristics according to various embodiments of the present invention, which includes trailing arms 12 and carriers 13 on which rear wheels RWs are mounted via carrier brackets 14 at both ends of a torsion beam 11 includes a mounting bracket 21 fixed to the bottom of a vehicle body and a steering rod 22 of which one end is linked to carrier 13 and the other end is linked to the mounting bracket 21.

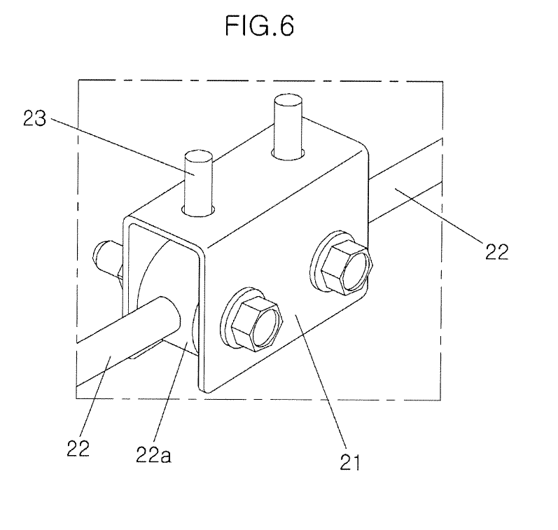

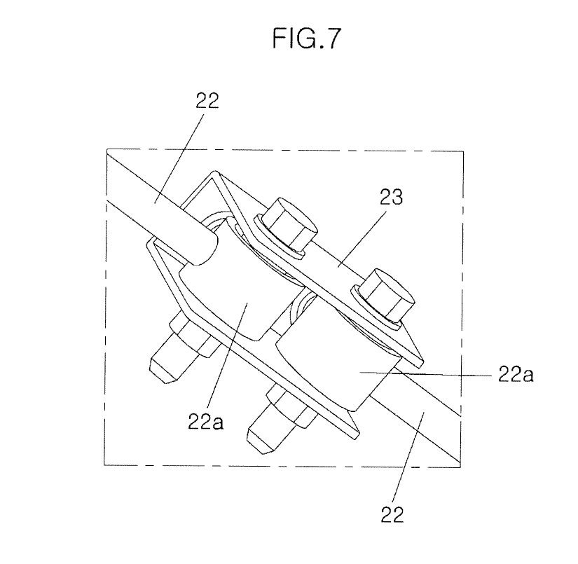

Mounting bracket 21 is mounted on the bottom of the vehicle body. Mounting bracket 21 has a cross section with a ‘U’ shape of which one side is opened by bending a plate material and is fixed to the bottom of the vehicle body by using an engagement bolt 23, as shown in FIGS. 6 and 7. An inner space of mounting bracket 21 corresponds to a space engaged with a bush 22a of steering rod 22 to be described below.

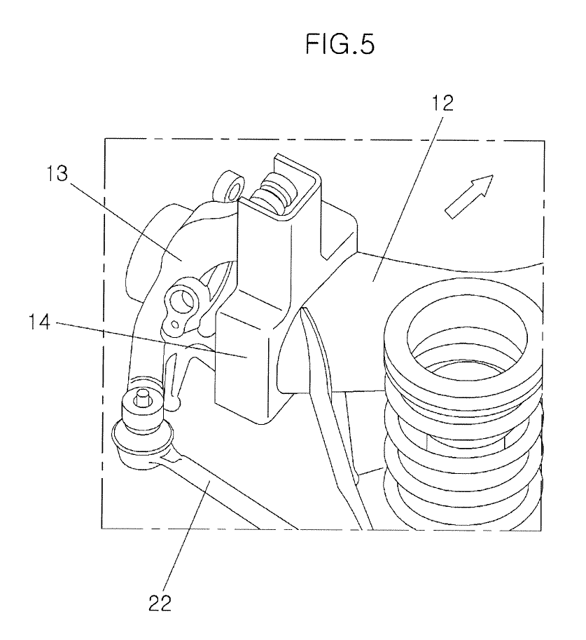

One end of steering rod 22 is linked to carrier 13 of CTBA 1 (see FIG. 5) and the other end thereof is linked to mounting bracket 21 (see FIGS. 6 and 7). Steering rods 22 are connected to left and right rear wheels RWs, respectively and a pair of steering rods 22 is linked to carriers 13 and mounting brackets 21 to be laterally symmetric. One end of steering rod 22 connected to carrier 13 is connected with carrier 13 by the ball joint or a bush and the other end thereof connected to mounting bracket 21 is connected with mounting bracket 21 by the pin joint.

In particular, bush 22a is formed at the other end of steering rod 22, such that steering rod 22 is connected to mounting bracket 21 through bush 22a by the pin joint.

As described above, when the pair of steering rods 22 is linked with torsion beam 11 substantially in parallel, mounting bracket 21 is positioned in the rear of the center of rear wheel RW and one end of steering rod 22 is connected to carrier 13 at a position lower than mounting bracket 21, in order to secure driving stability.

Specifically, as shown in FIG. 3, mounting bracket 21 is positioned in the rear of the center of the rear wheel, such that when side force Fs is applied while the vehicle turns round, a tow value of the rear wheel is induced to be towed in. That is, even though side force Fs is applied, one end of steering rod 22 supports a rear portion of rear wheel RW, and as a result, a front portion of rear wheel RW faces an inner part around the center to tow in rear wheel RW.

As shown in FIG. 4, one end of steering rod 22 connected with carrier 13 is linked with carrier 13 at a position lower than the other end connected with mounting bracket 21, such that the rear wheel is pushed outward to be towed in while bumping. For example, when an outer wheel of rear wheel RW is bumped (B) and an inner wheel thereof rebounds (R), steering rod 22 supports an upper portion of the outer wheel of the bumped rear wheel, and as a result, a lower portion faces the inner part around a portion on which rear wheel RW is mounted, thereby towing in the tow value.

As described above, since steering rod 22 supports the upper portion in the rear of the center of rear wheel RW, the tow value is towed in while the side force acts on rear wheel RW or rear wheel RW is bumped, thereby improving the driving stability.

For convenience in explanation and accurate definition in the appended claims, the terms upper or lower, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A coupled torsion beam axle (CTBA) with improved compliance characteristics, the CTBA comprising:
trailing arms and carriers on which rear wheels are mounted via carrier brackets at both ends of a torsion beam;
a mounting bracket fixed to a bottom of a vehicle body; and
a steering rod including one end linked to the carrier and another end linked to the mounting bracket.

2. The CTBA with improved compliance characteristics as defined in claim 1, wherein the steering rod is connected to the carrier by a ball joint or a bush.

3. The CTBA with improved compliance characteristics as defined in claim 1, wherein the one end of the steering rod is connected to the carrier at a height that is lower than the mounting bracket.

4. The CTBA with improved compliance characteristics as defined in claim 1, wherein the mounting bracket is positioned rearward of a center of the rear wheels.

5. The CTBA with improved compliance characteristics as defined in claim 1, wherein the mounting bracket has a cross section bent in a ‘U’ shape of which one side is opened, and the steering rod is inserted into an inner part of the mounting bracket and is connected with the mounting bracket by a pin joint.
